(19) United States
(12) Patent Application Publication
(10) Pub. No.: US 2015/0169207 A1
(43) Pub. Date: Jun. 18, 2015

(54) SYSTEMS AND METHODS FOR GENERATING PERSONALIZED ACCOUNT RECONFIGURATION INTERFACES

(71) Applicant: Dropbox, Inc., San Francisco, CA (US)

(72) Inventors: Viraj Mody, San Francisco, CA (US); Thomas Carriero, San Francisco, CA (US); Allison House, San Francisco, CA (US); Joshua Puckett, Mountain View, CA (US)

(73) Assignee: Dropbox, Inc., San Francisco, CA (US)

(21) Appl. No.: 14/132,951

(22) Filed: Dec. 18, 2013

(51) Int. Cl. G06F 3/0484; G06F 3/0482

(52) U.S. Cl. CPC G06F 3/04847; G06F 3/0482

(57) ABSTRACT

Embodiments are provided for generating personalized account reconfiguration interfaces to users of a content management system. A user interface including an option to reconfigure a user's account with a content management system may be provided that incorporates the user's own content. Generating the personalized account reconfiguration interface may include generating an account reconfiguration offer template that includes one or more object placeholders and identifying user content items to replace the object placeholders. The personalized account reconfiguration interface may then be provided to the user for display on a display of the user's electronic device.

### BACKGROUND

Economies of scale and increases in the availability of high-speed network connections have made it cheap and convenient for users to store digital content in a remote storage system instead of, or in addition to, local electronic device storage components. Besides simply storing users' data, such remote storage systems can offer various content management solutions to improve the user experience. Such solutions can provide users with basic functionality for free or for a relatively low price and more advanced functionality, such as additional features and/or storage, for an additional fee.

### SUMMARY

Systems and methods are provided for generating and displaying personalized account reconfiguration interfaces. A personalized account reconfiguration interface may be user interface customized with the user's own content or with attributes of the user's content. The user interface may be presented on the display of an electronic device in a manner that allows the user to experience the account reconfiguration as it would look if the reconfiguration were accepted. The personalized account configuration interface may include a nonfunctional mockup or a fully or partially functional demonstration of the particular account reconfiguration being presented.

In some embodiments, the user can receive a notification on a user device for display of a user interface page with an option to upgrade or activate a feature of a software application. The feature or application may relate to an expanded feature set for a type of content, for example, and the user interface page can include at least one object placeholder. The user device can then identify one or more user content items that could substitute for the at least one object placeholder. According to various embodiments, the user content items may be stored locally on the user device or stored in a data store of a user account accessible via the user device. Suitable user content items, once identified, may then be substituted for the placeholder content items and displayed within user interface.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIG. 1 depicts a schematic view of an exemplary content management system for generating personalized account reconfiguration interfaces, in accordance with some embodiments;

FIG. 2 depicts a user interface including an illustrative account reconfiguration interface template, in accordance with some embodiments;

FIG. 3 depicts a user interface including another illustrative account reconfiguration interface template, in accordance with some embodiments;

FIG. 4 shows a portion of an illustrative file system for identifying user content items to be included within a personalized account reconfiguration interface, in accordance with some embodiments;

FIG. 5 depicts an illustrative personalized account reconfiguration interface, in accordance with some embodiments;

FIG. 6 depicts a another illustrative personalized account reconfiguration interface, in accordance with some embodiments;

FIG. 7 shows a flowchart of an illustrative process for generating a personalized account reconfiguration interface, in accordance with some embodiments; and

FIG. 8 shows a flowchart of another illustrative process for generating a personalized account reconfiguration interface, in accordance with some embodiments.

### DETAILED DESCRIPTION OF THE DISCLOSURE

Methods, systems, and computer readable media for generating personalized account reconfiguration interfaces are presented. For purposes of description and simplicity, methods, systems and computer readable media will be described for a content storage and management service, and in particular, content item classification. However, the terms “content storage service” and “content management system” are used herein to refer broadly to a variety of storage providers and management service providers as well as handling a wide variety of types of content, files, portions of files, and/or other types of data. Those with skill in the art will recognize that the methods, systems, and media described may be used for a variety of storage providers/services and types of content, files, portions of files, and/or other types of data.

A personalized account reconfiguration interface may include an option to add, upgrade, or otherwise modify a user's account with a content management system that incorporates one or more of a user's own content items. Personalized account reconfiguration interfaces may be more engaging to the user than typical account reconfiguration interfaces, which merely present stock content items, because personalized interfaces permit the user to visualize the account reconfiguration as it would appear if the presented reconfiguration is accepted.

A content item may be any item that includes content accessible to a user of an electronic device. The use of “content item” or “content items” is used herein to refer broadly to various file types. In some embodiments, content items may include digital photographs, documents, music, videos, or any other type of file, or any combination thereof and should not be read to be limited to one specific type of content item. Moreover, the term content item may also refer to attributes associated with user files, including the file's metadata (e.g., filename, file size, etc.). In some embodiments the content items may be stored in memory of an electronic device, on a content management system, on a social media network, or any other location, or any combination thereof.

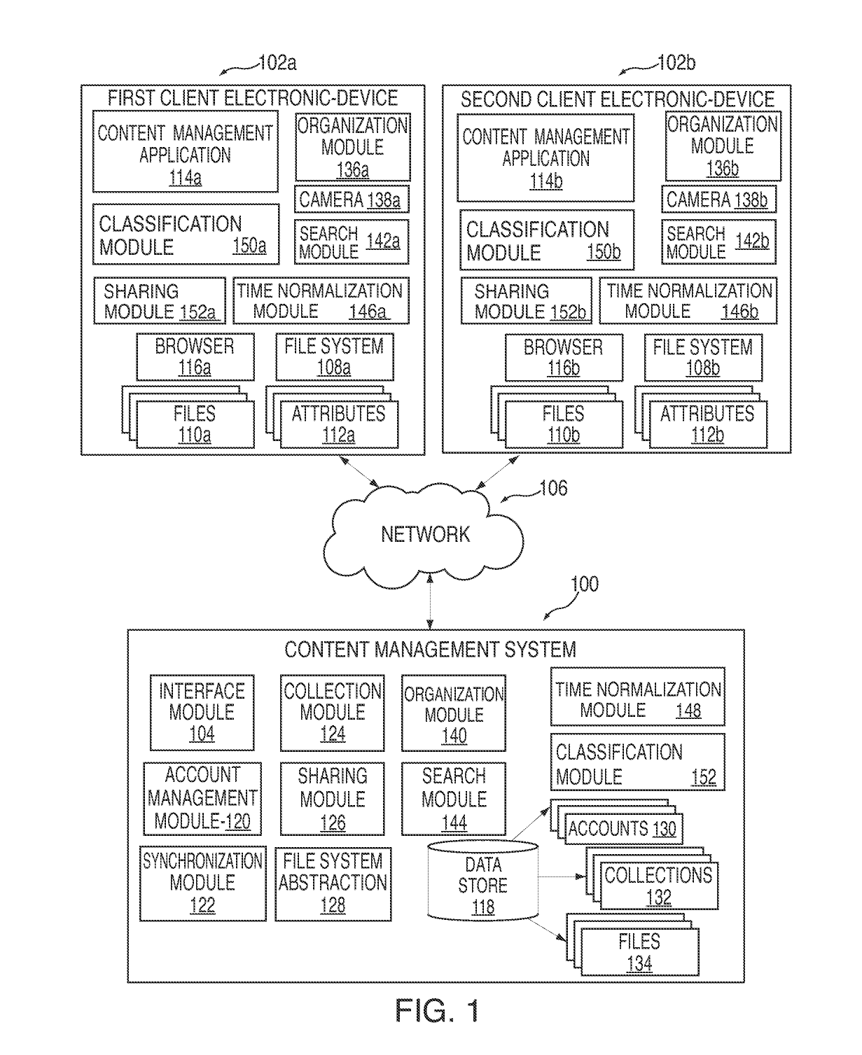

FIG. 1 depicts a schematic view of an exemplary content management system for generating personalized account reconfiguration interfaces in accordance with some embodiments of the invention. Elements in FIG. 1, including, but not limited to, first client electronic device 102a, second client electronic device 102b, and content management system 100 may communicate by sending and/or receiving data over network 106. Network 106 may be any network, combination of networks, or network devices that may carry data communication. For example, network 106 may be any one or any combination of LAN (local area network), WAN (wide area network), telephone network, wireless network, point-to point network, star network, token ring network, hub network, or any other configuration.

Network 106 may support any number of protocols, including, but not limited, to TCP/IP (Transfer Control Protocol and Internet Protocol), HTTP (Hypertext Transfer Protocol), and WAP (Wireless Application Protocol). For example, first client electronic device 102a and second client electronic device 102b (collectively 102) may communicate with content management system 100 using TCP/IP and, at a higher level, use web browser 116 to communicate with a web server (not shown) at content management system 100 using HTTP. Exemplary implementations of web browser 116 can include, but are not limited to, Google Inc. Chrome™ browser, Microsoft Internet Explorer®, Apple Safari®, Mozilla Firefox, and Opera Software Opera.

A variety of client electronic devices 102 may communicate with content management system 100, including, but not limited to, desktop computers, mobile computers, mobile communication devices (e.g., mobile phones, smart phones, tablets), televisions, set-top boxes, and/or any other network enabled device. Although two client electronic devices 102a and 102b are illustrated for description purposes, those with skill in the art will recognize that any number of devices may be used and supported by content management system 100. Client electronic devices 102 may be used to create, access, modify, and manage files 110a and 110b (collectively 110) (e.g. files, file segments, images, etc.) stored locally within file system 108a and 108b (collectively 108) on client electronic device 102 and/or stored remotely with content management system 100 (e.g., within data store 118).

In some embodiments, a client electronic device may be permitted to access, modify, and/or manage files that were originally uploaded to data store 118 by another client electronic device. For example, client electronic device 102a may access file 110b stored remotely with data store 118 and may or may not store file 110b locally within file system 108a on client electronic device 102a depending, for example, on sharing permissions defined for the files. Continuing with the example, client electronic device 102a may temporarily store file 110b within a cache (not shown) locally within client electronic device 102a, make revisions to file 110b, and communicate the revisions to file 110b to data store 118. Optionally, a local copy of the file may be stored on client electronic device 102a (e.g., in files 110a).

Client electronic devices 102 may include camera 138 (e.g., cameras 138a and 138b) to capture and record digital images and/or videos, which may be stored locally in files 110. Additionally, camera 138 may store metadata with the images along with the images and/or videos captured by camera 138. Such metadata may include, for example, creation time timestamp, geolocation, orientation, rotation, title, and/or any other attributes or data relevant to the captured image.

Metadata values may be stored within attributes 112 as name-value pairs, tag-value pairs, and/or any other method to associate the metadata with the file and easily identify the type of metadata. In some embodiments, attributes 112 may be tag-value pairs defined by a particular standard, including, but not limited to, Exchangeable Image File Format (Exif), JPEG File Interchange Format (Jfif), and/or any other standard.

Time normalization module 146 (e.g., organization modules 146a and 146b) may be used to normalize dates and times stored with a content item. Time normalization module 146, resident on client electronic device 102, counterpart time normalization module 148, resident on content management system 100, and/or any combination thereof may be used to normalize dates and times stored for content items. The normalized times and dates may be used to sort, group, cluster, perform comparisons between, and/or perform basic math function on content items.

Organization module 136 (e.g., organization modules 136a and 136b) may be used to organize content items into clusters, organize content items to provide samplings of content items for display within user interfaces, and/or retrieve organized content items for presentation.

Organization module 136 may use any suitable clustering algorithm identify and organize similar content items into clusters. Such clusters may facilitate organized presentation of content items within user interfaces displayed client electronic devices 102 and content management system 100. In some embodiments, similarity rules may be defined to create one or more numeric representations embodying information regarding similarities between each of the content items. Organization module 136 may use the numeric representations as references for similarity between content items in order to cluster the content items.

In some embodiments, content items may be organized into clusters to aid with retrieval of similar content items in response to search requests. For example, organization module 136a may identify that two images are similar and group the images together in a cluster. Organization module 136a may process content items to determine clusters independently or in conjunction with a counterpart organization module (e.g., organization module 140 and/or 136b). In other embodiments, organization module 136a may only provide clusters identified with counterpart organization modules for presentation. Continuing with the example, processing of content items to determine clusters may be an iterative process executed upon receipt of new content items and/or new similarity rules.

In some embodiments, search module 142 on client electronic device 102 can be provided with counterpart search module 144 on content management system 100 to support content item searches. A search request may be received by search module 142 and/or 144 that requests a content item. In some embodiments, the search may be handled by searching metadata and/or attributes 112 associated with content items during the provision of management services. For example, cluster markers stored with images may be used to find images by date. In particular, cluster markers may indicate an approximate time or average time for the images stored with the cluster marker in some embodiments, and the markers may be used to speed the search and/or return the search results with the contents of the cluster with particular cluster markers.

Files 110 managed by content management system 100 may be stored locally within file system 108 of client electronic devices 102 and/or stored remotely within data store 118 of content management system 100 (e.g., files 134 in data store 118). Content management system 100 may provide synchronization of files managed by content management system 100. Attributes 112a and 112b (collectively 112) or other metadata may also be stored with files 110. For example, a particular attribute may be stored with the file to track files locally stored on client electronic devices 102 that are managed and/or synchronized by content management system 100. In some embodiments, attributes 112 may be implemented using extended attributes, resource forks, or any other implementation that allows for storing metadata with a file that is not interpreted by a file system. In particular, attributes 112 can include a content identifier for a file. For example, the content identifier may be a unique or nearly unique identifier (e.g., number or string) that identifies the file.

By storing a content identifier with the file, a file may be tracked. For example, if a user moves the file to another location within the file system 108 hierarchy and/or modifies the file, then the file may still be identified within the file system 108 of client electronic device 102. Any changes or modifications to the file identified with the content identifier may be uploaded or provided for synchronization and/or version control services provided by the content management system 100.

Content management application 114a and 114b (collectively 114), which may be a stand-alone application installed on client electronic device 102, a web-based client application, and/or a third-party application may be implemented to provide a user interface for a user to interact with content management system 100. Content management application 114 may expose the functionality provided with interface module 104 and accessible modules for client electronic device 102. Web browser 116a and 116b (collectively 116) may be used to display a web page front end for a client application that may provide content management functionality exposed/provided with interface module 104.

Content management system 100 may allow a user with an authenticated account to store content, as well as perform management tasks, such as retrieve, modify, browse, synchronize, and/or share content with other accounts. Various embodiments of content management system 100 may have elements, including, but not limited to, interface module 104, account management module 120, synchronization module 122, collections module 124, sharing module 126, file system abstraction 128, data store 118, and organization module 140. The interface module 104 may expose the server-side or back end functionality/capabilities of content management system 100. For example, a counter-part user interface on client electronic devices 102 may be implemented using interface module 104 to allow a user to perform functions offered by modules of content management system 100. In particular, content management system 100 may have an organization module 140 for identifying similar content items for clusters and samples of content items for presentation within user interfaces.

The user interface offered on client electronic device 102 may be used to create an account for a user and authenticate a user to use an account using account management module 120. The account management module 120 of the content management service may provide the functionality for authenticating use of an account by a user and/or client electronic device 102 with username/password, device identifiers, and/or any other authentication method. Account information 130 may be maintained in data store 118 for accounts. Account information may include, but is not limited to, personal information (e.g., an email address or username), account management information (e.g., account type, such as “free” or “paid”), usage information, (e.g., file edit history), maximum storage space authorized, storage space used, content storage locations, security settings, personal configuration settings, content sharing data, etc. An amount of content management storage space may be reserved, allotted, allocated, stored, and/or may be accessed with an authenticated account. The account may be used to access files 110 within data store 118 for the account and/or files 110 made accessible to the account that are shared from another account. Account management module 120 may interact with any number of other modules of content management system 100.

An account may be used to store content, such as documents, text files, audio files, video files, etc., from one or more client electronic devices 102 authorized on the account. The content may also include folders of various types with different behaviors, or other mechanisms of grouping content items together. For example, an account may include a public folder that is accessible to any user. The public folder may be assigned a web-accessible address. A link to the web-accessible address may be used to access the contents of the public folder. In another example, an account may include a ‘photos’ folder that is intended for photos and that provides specific attributes and actions tailored for photos; an audio folder that provides the ability to play back audio files and perform other audio related actions; or other special purpose folders. An account may also include shared folders or group folders that are linked with and available to multiple user accounts. The permissions for multiple users may be different for a shared folder.

Content items (e.g., files 110) may be stored in data store 118. Data store 118 may be a storage device, multiple storage devices, or a server. Alternatively, data store 118 may be cloud storage provider or network storage accessible via one or more communications networks. Content management system 100 may hide the complexity and details from client electronic devices 102 by using file system abstraction 128 (e.g., a file system database abstraction layer) so that client electronic devices 102 do not need to know exactly where the content items are being stored by the content management system 100. Embodiments may store the content items in the same folder hierarchy as they appear on client electronic device 102. Alternatively, content management system 100 may store the content items in various orders, arrangements, and/or hierarchies. Content management system 100 may store the content items in a network accessible storage (SAN) device, in a redundant array of inexpensive disks (RAID), etc. Content management system 100 may store content items using one or more partition types, such as FAT, FAT32, NTFS, EXT2, EXT3, EXT4, ReiserFS, BTRFS, and so forth.

Data store 118 may also store metadata describing content items, content item types, and the relationship of content items to various accounts, folders, collections, or groups. The metadata for a content item may be stored as part of the content item and/or may be stored separately. Metadata may be stored in an object-oriented database, a relational database, a file system, or any other collection of data. In one variation, each content item stored in data store 118 may be assigned a system-wide unique identifier.

Data store 118 may decrease the amount of storage space required by identifying duplicate files or duplicate chunks of files. Instead of storing multiple copies, data store 118 may store a single copy of a file in files 134 and then use a pointer or other mechanism to link the duplicates to the single copy. Similarly, data store 118 may store files 134 more efficiently, as well as provide the ability to undo operations, by using a file version control that tracks changes to files, different versions of files (including diverging version trees), and a change history. The change history may include a set of changes that, when applied to the original file version, produce the changed file version.

Content management system 100 may be configured to support automatic synchronization of content from one or more client electronic devices 102. The synchronization may be platform independent. That is, the content may be synchronized across multiple client electronic devices 102 of varying type, capabilities, operating systems, etc. For example, client electronic device 102a may include client software, which synchronizes, via synchronization module 122 at content management system 100, content in file system 108 of client electronic device 102 with the content in an associated user account. In some cases, the client software may synchronize any changes to content in a designated folder and its sub-folders, such as new, deleted, modified, copied, or moved files or folders. In one example of client software that integrates with an existing content management application, a user may manipulate content directly in a local folder, while a background process monitors the local folder for changes and synchronizes those changes to content management system 100. In some embodiments, a background process may identify content that has been updated at content management system 100 and synchronize those changes to the local folder. The client software may provide notifications of synchronization operations, and may provide indications of content statuses directly within the content management application. Sometimes client electronic device 102 may not have a network connection available. In this scenario, the client software may monitor the linked folder for file changes and queue those changes for later synchronization to content management system 100 when a network connection is available. Similarly, a user may manually stop or pause synchronization with content management system 100.

A user may also view or manipulate content via a web interface generated and served by interface module 104. For example, the user may navigate in a web browser to a web address provided by content management system 100. Changes or updates to content in the data store 118 made through the web interface, such as uploading a new version of a file, may be propagated back to other client electronic devices 102 associated with the user's account. For example, multiple client electronic devices 102, each with their own client software, may be associated with a single account and files in the account may be synchronized between each of the multiple client electronic devices 102.

Content management system 100 may include sharing module 126 for managing sharing content and/or collections of content publicly or privately. Sharing module 126 may manage sharing independently or in conjunction with counterpart sharing module (e.g., 152a and 152b). Sharing content publicly may include making the content item and/or the collection accessible from any computing device in network communication with content management system 100. Sharing content privately may include linking a content item and/or a collection in data store 118 with two or more user accounts so that each user account has access to the content item. The sharing may be performed in a platform independent manner. That is, the content may be shared across multiple client electronic devices 102 of varying type, capabilities, operating systems, etc. The content may also be shared across varying types of user accounts. In particular, the sharing module 126 may be used with the collections module 124 to allow sharing of a virtual collection with another user or user account. A virtual collection may be a grouping of content identifiers that may be stored in various locations within file system of client electronic device 102 and/or stored remotely at content management system 100.

The virtual collection for an account with a file storage service is a grouping of one or more identifiers for content items (e.g., identifying content items in storage). The virtual collection is created with the collections module 124 by selecting from existing content items stored and/or managed by the file storage service and associating the existing content items within data storage (e.g., associating storage locations, content identifiers, or addresses of stored content items) with the virtual collection. By associating existing content items with the virtual collection, a content item may be designated as part of the virtual collection without having to store (e.g., copy and paste the content item file to a directory) the content item in another location within data storage in order to place the content item in the collection.

In some embodiments, content management system 100 may be configured to maintain a content directory or a database table/entity for content items where each entry or row identifies the location of each content item in data store 118. In some embodiments, a unique or a nearly unique content identifier may be stored for each content item stored in the data store 118.

Metadata may be stored for each content item. For example, metadata may include a content path that may be used to identify the content item. The content path may include the name of the content item and a folder hierarchy associated with the content item (e.g., the path for storage locally within a client electronic device 102). In another example, the content path may include a folder or path of folders in which the content item is placed as well as the name of the content item. Content management system 100 may use the content path to present the content items in the appropriate folder hierarchy in a user interface with a traditional hierarchy view. A content pointer that identifies the location of the content item in data store 118 may also be stored with the content identifier. For example, the content pointer may include the exact storage address of the content item in memory. In some embodiments, the content pointer may point to multiple locations, each of which contains a portion of the content item.

In addition to a content path and content pointer, a content item entry/database table row in a content item database entity may also include a user account identifier that identifies the user account that has access to the content item. In some embodiments, multiple user account identifiers may be associated with a single content entry indicating that the content item has shared access by the multiple user accounts.

To share a content item privately, sharing module 126 may be configured to add a user account identifier to the content entry or database table row associated with the content item, thus granting the added user account access to the content item. Sharing module 126 may also be configured to remove user account identifiers from a content entry or database table rows to restrict a user account's access to the content item. The sharing module 126 may also be used to add and remove user account identifiers to a database table for virtual collections.

To share content publicly, sharing module 126 may be configured to generate a custom network address, such as a uniform resource locator (URL), which allows any web browser to access the content in content management system 100 without any authentication. To accomplish this, sharing module 126 may be configured to include content identification data in the generated URL, which may later be used to properly identify and return the requested content item. For example, sharing module 126 may be configured to include the user account identifier and the content path in the generated URL. Upon selection of the URL, the content identification data included in the URL may be transmitted to content management system 100 which may use the received content identification data to identify the appropriate content entry and return the content item associated with the content entry.

To share a virtual collection publicly, sharing module 126 may be configured to generate a custom network address, such as a uniform resource locator (URL), which allows any web browser to access the content in content management system 100 without any authentication. To accomplish this, sharing module 126 may be configured to include collection identification data in the generated URL, which may later be used to properly identify and return the requested content item. For example, sharing module 126 may be configured to include the user account identifier and the collection identifier in the generated URL. Upon selection of the URL, the content identification data included in the URL may be transmitted to content management system 100 which may use the received content identification data to identify the appropriate content entry or database row and return the content item associated with the content entry or database row.

In addition to generating the URL, sharing module 126 may also be configured to record that a URL to the content item has been created. In some embodiments, the content entry associated with a content item may include a URL flag indicating whether a URL to the content item has been created. For example, the URL flag may be a Boolean value initially set to 0 or false to indicate that a URL to the content item has not been created. Sharing module 126 may be configured to change the value of the flag to 1 or true after generating a URL to the content item.

In some embodiments, sharing module 126 may also be configured to deactivate a generated URL. For example, each content entry may also include a URL active flag indicating whether the content should be returned in response to a request from the generated URL. For example, sharing module 126 may be configured to only return a content item requested by a generated link if the URL active flag is set to 1 or true. Changing the value of the URL active flag or Boolean value may easily restrict access to a content item or a collection for which a URL has been generated. This allows a user to restrict access to the shared content item without having to move the content item or delete the generated URL. Likewise, sharing module 126 may reactivate the URL by again changing the value of the URL active flag to 1 or true. A user may thus easily restore access to the content item without the need to generate a new URL

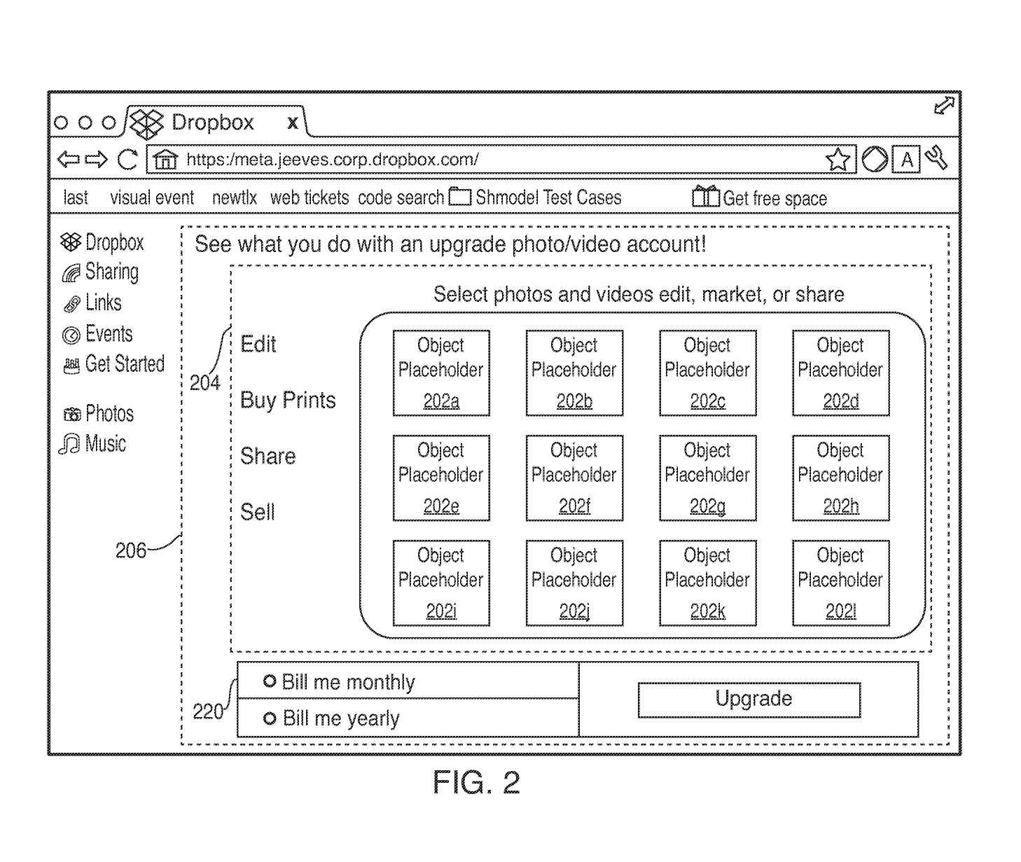

FIG. 2 depicts user interface 200 including illustrative account reconfiguration interface template 206, in accordance with some embodiments. User interface 200 may include object placeholders 202a-l displayed within demonstration portion 204, which may in turn, be displayed within account reconfiguration interface template 206. Demonstration portion 204 and account reconfiguration interface template 206 are displayed within dashed lines for purposes of clarity, and the dashed lines are not meant to be understood as part of the user interface design. Generally speaking, user interface 200 may be a template for a personalized account reconfiguration interface that is to be presented to a user account authenticated with a content management system (e.g., content management system 100 of claim 1) as an advertisement and/or enticement to reconfigure (e.g., upgrade or otherwise modify) the user's account. However, it should be recognized that in some embodiments, the user receiving a personalized account reconfiguration interface may not have an authenticated account with the content management system.

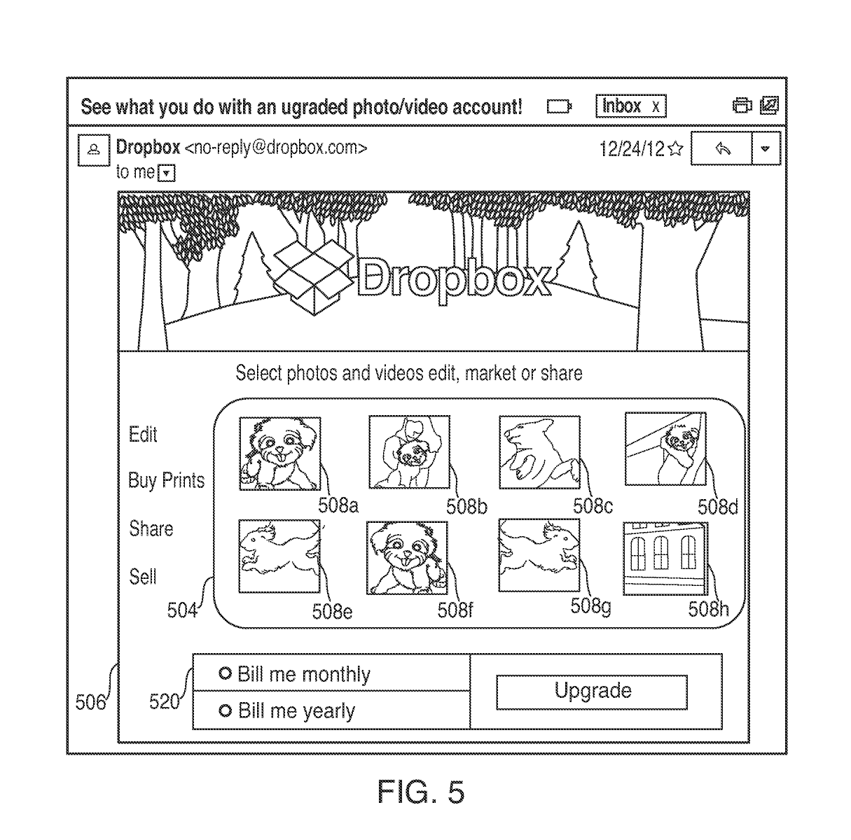

The content management system can include object placeholders 202a-l within user interface 200 to provide structure to and define the layout of the personalized account reconfiguration interface to be presented to the user (e.g., account reconfiguration interface 506 displayed in user interface 500 of FIG. 5, below). Object placeholders 202a-l may be objects that are designed to be replaced with one or more user content items (e.g., images or videos) or attributes associated with user content items (e.g., file names). Accordingly, object placeholders 202a-l may or may not be visible within user interface 200. In fact, object placeholders 202a-l may not be “objects” at all; rather, object placeholders 202a-l may simply be cells of a table or another suitable layout-defining feature. In some embodiments, however, object placeholders 202a-l may be populated with default content items (e.g., content items provided by the content management system). Default content items may be similar to content items presented to a user in a typical nonpersonalized account reconfiguration interface, and may include, for example, stock images and/or videos.

Object placeholders 202a-l may be displayed in demonstration portion 204 of user interface 200, which may represent one or more aspects of the account reconfiguration being presented. According to some embodiments, demonstration portion 204 may present to the user a fully-functional demonstration of the presented account reconfiguration in which the user may be permitted to interact with objects (e.g., content items and/or links) and try out advanced features associated with the account reconfiguration. Providing a fully functional demonstration portion 204 as part of a personalized account reconfiguration may be particularly effective for convincing a user to upgrade their user account because it may allow the user to experience what it would be like to interact with the user's own content items in the reconfigured client software. In other embodiments, demonstration portion 204 may be only partially functional (e.g., the user may be permitted to interact with content items but not access advanced features like editing or sharing the content items). In still further embodiments, demonstration portion 204 may be a nonfunctional demonstration (e.g., a screenshot of what the user interface would look like if the user upgraded).

Although only twelve placeholder content items are displayed within user interface 200, it should be understood the number and size of placeholder content items displayed within a particular personalized account reconfiguration interface may vary according to a number of factors, such as the amount of available real estate available on the user's display, the type of user device viewing the user interface, the type of account reconfiguration being presented, and/or the format in which the account reconfiguration is presented, for example.

As one example, the content management system may generate different user interfaces depending on the type of electronic device used to view the personalized account reconfiguration interface. User interface 200, for example, is displayed within an Internet browser window of the type commonly used on desktop and laptop computers. Because user interface 200 might be difficult to navigate using a different type of electronic device, such as a smartphone, for example, the user interface presenting the account reconfiguration interface may be optimized for different device platforms. In some embodiments, the demonstration portion of the user interface generated for a particular type of electronic device may mimic the layout of the client software as it is rendered for that device type. That is, if the client user interface that is presented on a particular type of device may also be presented in the demonstration portion of a user interface of a personalized account reconfiguration interface.

According to some embodiments, user interface 200 can also include upgrade portion 220. Upgrade portion 220 may provide the user with various options related to proceeding with the presented account reconfiguration.

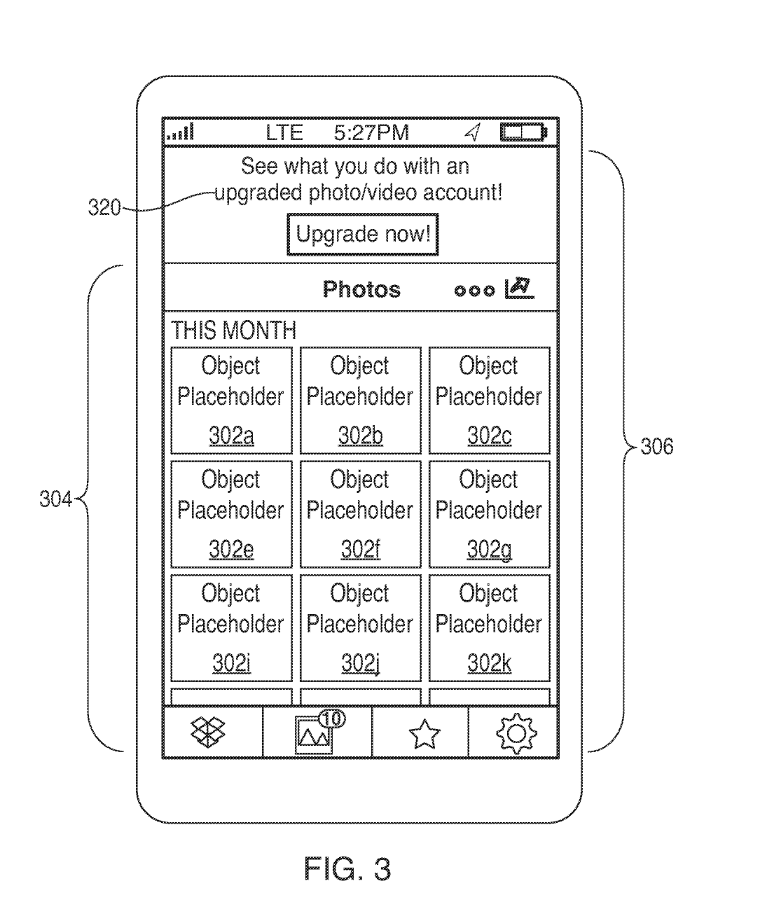

FIG. 3 depicts a user interface 300 including illustrative account reconfiguration interface template 306, in accordance with some embodiments. In particular, user interface 300 may be specifically designed for display on a portable electronic device such as a smartphone or tablet, for example. User interface 300 can include object placeholders 302a-n displayed within a demonstration portion 304, which may in turn, be displayed within account reconfiguration interface template 306. User interface 300 may also include upgrade portion 320. As described above with respect to user interface 200 of FIG. 2, object placeholders 302a-k can be layout features that are meant to be replaced with user content items as part of a personalized account reconfiguration interface. Additionally, demonstration portion 304 may present a fully-functional, partially functional, or nonfunctional demonstration of the features associated with the account reconfiguration, according to various embodiments.

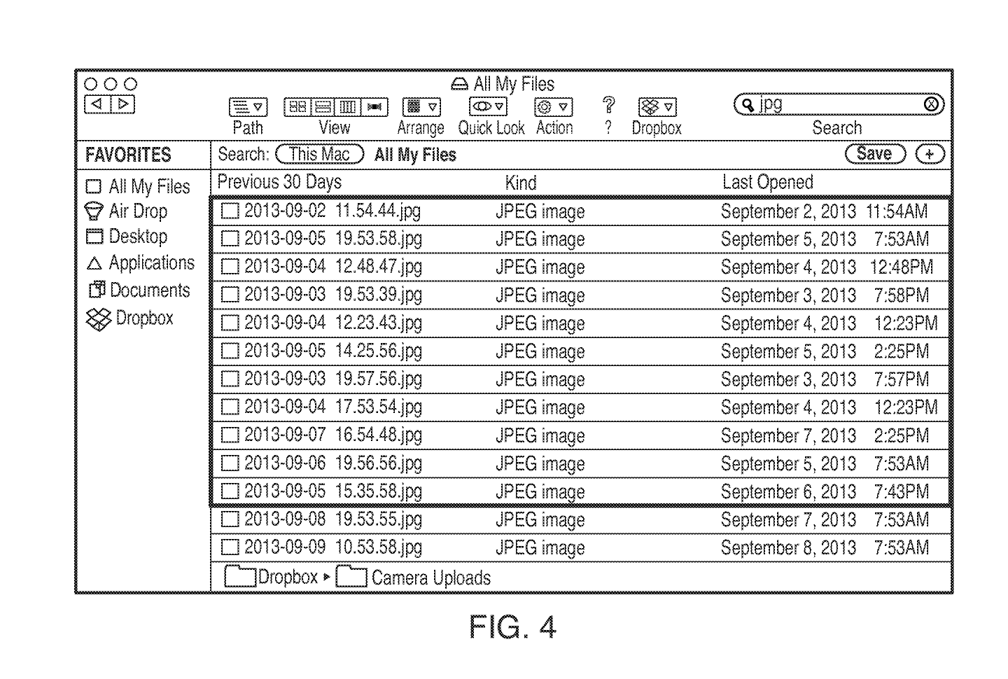

When the content management system determines that it will present a personalized account reconfiguration interface to the user, the content management system may identify user content items to replace object placeholders provided in an account reconfiguration interface template (e.g., within user interface 200 and/or user interface 300). FIG. 4 shows a portion of illustrative file system 408 for identifying user content items to be included within a personalized account reconfiguration interface, in accordance with some embodiments. File system 408 may be the file system of a client electronic device (e.g., file system 108a of client electronic device 102a of FIG. 1) and may organize and control access to files 410 stored on the client electronic device.

If file system 408 is stored on a client electronic device of a user with an authenticated account with the content management system, the content management system may have access to some or all files 410 in file system 408. This access may be facilitated by use of a content management application (e.g., content management application 114a of FIG. 1) installed on the client electronic device. The level of access given to the content management system may depend on several factors, including permissions set by the user outside of the content management application, permissions set by the user within the content management application, and restrictions built directly into the content management application, for example. The user controlled permissions or application controlled permissions may define which files of files 110 are accessible to the content management system and what level of access the content management system is permitted.

For example, when a user installs a content management application on their client electronic device, the content management system may be given read/write access to one or more designated folders of file system 408. According to various embodiments, the designated folders may be created at the time the content management application is installed, or already existing folders of file system 408 may be designated upon installation of the content management application. The content management system may have sufficient permissions (e.g., read/write/modify access) with respect to files 410 in such designated folders to permit synchronization between the client electronic device and a data store (e.g., data store 118) of the content management system. Given sufficient access to file system 408, the content management system may identify one or more of files 410 for incorporation into a personalized account reconfiguration interface. For example, the content management system can replace object placeholders of an account reconfiguration interface template (e.g., object placeholders 202a-l of FIG. 2) with content items chosen from files 410. In some embodiments, replacing the object placeholders with user content items can include embedding the user content items into the account reconfiguration interface template. In other embodiments, however, the content management system may simply replace the object placeholder with a destination link or file path at which the user content item can be accessed.

According to some embodiments, the identified content items may be transferred to the content management system via a network (e.g., network 106 of FIG. 1). The content management system can then generate a personalized account reconfiguration interface by replacing object placeholders of the account reconfiguration interface template with the identified content items. The personalized account reconfiguration interface can then be provided to the user in any suitable manner, such as via e-mail, via an Internet web page, and/or in a user interface of the content management application.

The transfer of identified content items from the client electronic device to the data store of the content management system may occur at any suitable time that a network connection is available. According to some embodiments, the identified content items can be transferred to the content management system following a request from the content management system. Such a request may be sent, for example, when the content management system decides to provide an account reconfiguration interface to the user (e.g., when new features of the content management system become available or when the user's usage of the content management system indicates that he or she may be amenable to the presented account reconfiguration). In such embodiments, the client electronic device can receive the request, transmit the identified content items to the content management system over the network, and receive a personalized account reconfiguration interface that includes their content items.

According to some embodiments, the identified content items may be transferred from the client electronic device to the content management system prior to the client electronic device receiving a request from the content management system. For example, content items may be transferred from the client electronic device to the content management system as part of a synchronization of files coordinated by a synchronization module of the content management system (e.g., synchronization module 122). In these embodiments, the content management system may identify content items associated with the user's account for inclusion within a personalized account reconfiguration interface. For instance, the content management system can identify content items associated with the user's account that are stored in a data store (e.g., data store 118 of FIG. 1) of the content management system, replace object placeholders of an account reconfiguration interface template with the identified content items to generate a personalized account reconfiguration interface, and present the personalized account reconfiguration interface to the user (e.g., as via e-mail, via an Internet web page, and/or in a user interface of the content management application).

In still further embodiments, the content management system may transmit a personalized account reconfiguration interface to the user's client electronic device without first embedding user content items in place of the object placeholders. Rather, the account reconfiguration interface template may include destination links and/or file paths that can be followed to identify a user content item for inclusion within the personalized account reconfiguration interface. Such embodiments may be advantageous if the user has set read-only permissions on files accessible to the content management system, for example, because the content management application may not sufficient authority to actually transfer user content items from the client electronic device to the content management system. However, with read-access to the user's files, the content management system may be permitted to access file paths for the user's content items and include those file paths within an account reconfiguration interface such that when the user views the account reconfiguration interface on their client electronic device, the template can be populated with user content items.

Similarly, if the content management system has access to a user's content items that are stored remotely (e.g., not on the client electronic device and not within a data store of the content management system), the content management system can identify content items accessible at those destination links, replace object placeholders of an account reconfiguration interface template with the destination links (e.g., hyperlinks), and provide the personalized account reconfiguration interface to the user.

In still further embodiments, the content management system may present a personalized account reconfiguration interface to individuals who have not given the content management system sufficient access to the file system of a client electronic device for the content management system to identify content items for incorporation into a personalized account reconfiguration interface. Such embodiments may allow for personalized account reconfiguration interfaces to be presented to users who have disallowed the content management application from accessing the local file system of the client electronic device or those who do not have authenticated accounts with the content management system at all. Personalized account reconfiguration interfaces may be generated for these types of users by relying on common file paths and file naming conventions for files stored on a client electronic device. Even if a content management system installed on the client electronic device may not be permitted to browse the local file system, the content management system may attempt to replace object placeholders of an account reconfiguration interface template with typical file paths and file names associated with content of a particular type.

The content management system may also append popular file names to the end of typical file paths in an attempt to arrive at a user's content items. For example, if the content management system attempts to display image files within the personalized account reconfiguration interface, the file names appended to the file path can be variants on “img0001.jpg.” Thus, the content management system may provide a personalized account reconfiguration interface to a user even without access to the user's file system. In the event that the file paths and file names that replace the object placeholders are not associated with a user content item, default objects (e.g., stock images) provided by the content management system can be displayed to the user. The personalized account reconfiguration interface may attempt to populate a personalized account reconfiguration interface with more than one typical file path/file name combination (e.g., 10, 100, or 1000) before resorting to presenting the account reconfiguration interface with default content items. Pseudocode representing for attempting typical file path/file name combinations might include:

```
function file_name_guess
set N = # of object placeholders to replace;
set M = # of file path/file name combinations;
for (i = 1; i≦N; i++) {
        for (j = 1; j≦M; j++) {
                embed (default_content_item_i);
                if user_content_item_j == found
                        embed (user_content_item_j);
                        j=M+1;
        }
}
```

Further, the content management system may compile information about the user's client electronic device (e.g., type of device, type of operating system, etc.) based on any interaction the client electronic device initiates with the content management system. For example, if the user accesses a website associated with the content management system with a client electronic device, the content management system may learn some attributes associated with that device in order to narrow down the file path/file name combinations that can be attempted in the course of providing a personalized account reconfiguration interface. Thus, if the client electronic device that accesses the content management system's website is an iPhone®, the content management system can provide personalized account reconfiguration interfaces to that device with file path/file name combinations commonly used on the iPhone®. Similarly, certain peripheral electronic device (e.g., digital cameras) use proprietary naming conventions for files generated. The file path/file name combinations attempted in these embodiments may include such proprietary naming conventions.

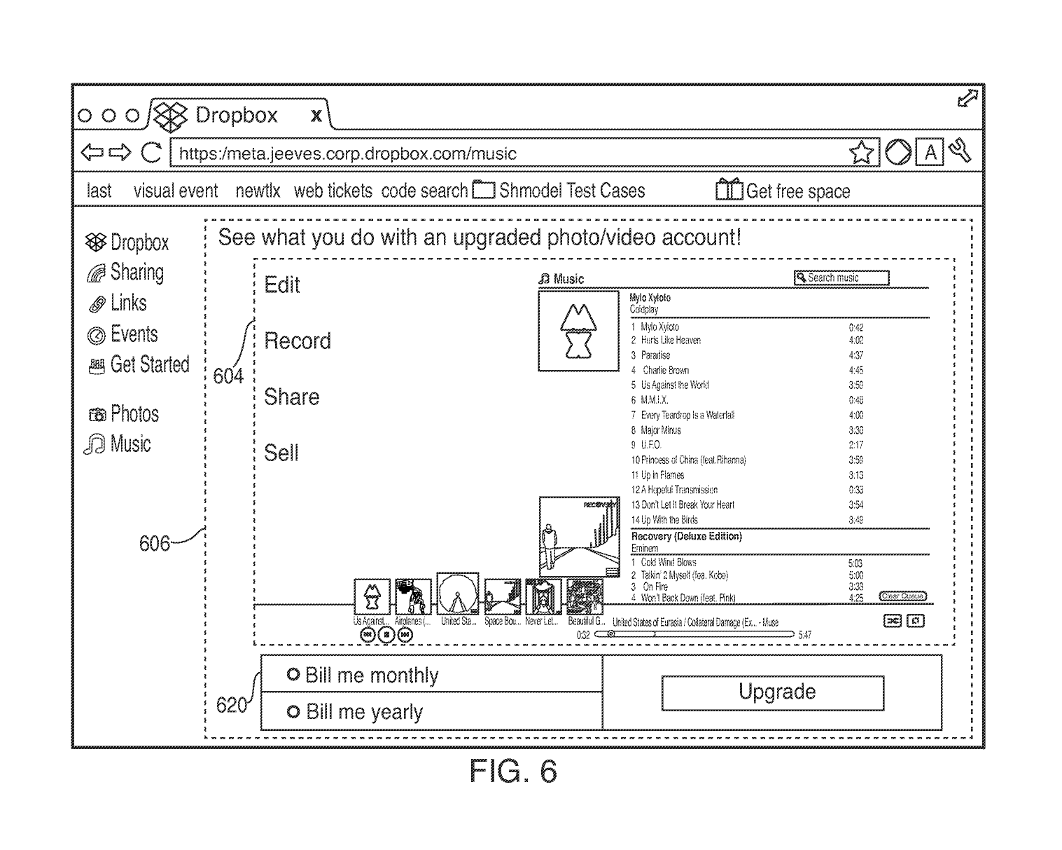

According to some embodiments, the personalized account reconfiguration interface may be primarily associated with a particular type of content. The account reconfiguration interface template displayed in user interface 200 of FIG. 2, for example, can represent an account reconfiguration associated with expanded features for editing, marketing, and sharing photos and videos. The type of user content items identified for inclusion within the personalized account reconfiguration interface may be of the same general type as the type of content being advertised in the interface. For example, the content management system can identify image and/or video files from among the user's content items for inclusion within personalized account reconfiguration interface 506 of FIG. 5, below, while the content management system may identify music files for inclusion within a music-related account reconfiguration interface (e.g., personalized account reconfiguration interface 606 of FIG. 6, below).

The content management system (e.g., working together with the content management application) may use any suitable filtering algorithm(s) to choose appropriate types of user content items to include within a personalized account reconfiguration interface. One simple filtering algorithm may search for files within a user's file system with file extensions that match the type of content being presented in the account reconfiguration interface. Thus, if the presented account reconfiguration relates primarily to photos, the content management system can identify files within the user's file system that have typical image file extensions, such as .jpg, .gif, or .tiff, for example. As another example, if the presented account reconfiguration relates primarily to music, the content management system can identify files within the user's file system that have typical audio file extensions, such as .mp3, .aac, .ogg, or .wav, for example.

In addition, the content management system may use any suitable sorting algorithm(s) to choose which individual user content items to include within a personalized account reconfiguration interface. The sorting algorithm(s) that choose content items for an account reconfiguration primarily associated with photos and images, for example, can select images using various criteria, such as: the N most recent photos, the N most accessed photos, older photos, photos of a specific person associated with the user, photos taken within a defined range of a place and/or a time, etc. For an account reconfiguration associated primarily with audio files, on the other hand, the sorting algorithm(s) may identify the N most recently added audio files, the N most recently shared audio files, N audio files that match a recently downloaded genre, N audio files that match a particular artist or group, and/or N audio files that match an artist the user just bought tickets for, etc. It should be understood that N may represent the number of user content items identified for inclusion within a personalized account reconfiguration interface, and N may be greater than, less than, or equal to a number of object placeholders in the account reconfiguration interface template. If the number of user content items identified is less than the number of object placeholders in the account reconfiguration interface template, some object placeholders may be replaced with default objects.

In embodiments in which a content management application resident on the client electronic device performs the identifying, the filtering and sorting algorithms may utilize file-system navigation tools to identify which content items to choose for inclusion within a personalized account reconfiguration interface. The file system navigation tools may permit the filtering and sorting of files using metadata associated with those files, for example. The metadata associated with each file in the file system may store information about the file, such as the file name, file type, file size, date created, date modified, author(s), and various tags (e.g., geolocation, orientation, rotation), for example. Any of these or other defined metadata fields may be used to sort and/or filter the user's files to identify suitable content items for inclusion within a personalized account reconfiguration interface.

One or more of the metadata fields associated with files in a user's file system may be preserved when a user synchronizes content items with the content management system. Additionally, further metadata fields may be added to each content item when it is received at the content management system. For instance, the content management system may attach a content identifier to a synchronized content item to facilitate the inclusion of content items within collections recognizable by the content management system. In embodiments in which user content items are identified from files associated with a user's account that are stored in the data store of the content management system, any available metadata attributes preserved and stored in the data store may be used to filter and/or sort the user's content items for inclusion within a personalized account reconfiguration interface.

FIG. 5 depicts user interface 500 including illustrative personalized account reconfiguration interface 506, in accordance with some embodiments. In particular, user interface 500 may include personalized account reconfiguration interface 506 in the body of an e-mail message. Personalized account reconfiguration interface 506 may incorporate user content items 508a-h within demonstration portion 504. User interface 500 may also include typical e-mail user interface elements, such as a subject line, header, and various other e-mail related elements, and upgrade portion 520.

Personalized account reconfiguration interface 506 may correspond to account reconfiguration interface template 206 of FIG. 2 after personalization. As described above, personalization of an account reconfiguration interface template can include replacing object placeholders (e.g., object placeholders 202a-l) with user content items (e.g., user content items 208a-h). Replacing object placeholders with user content times may involve embedding user content items into the account reconfiguration interface template and/or replacing object placeholders with file paths and/or destination links to user content items. In any case, the result may be an account reconfiguration interface that is personalized with a user's own content items.

As described above, the number of displayed user content items may be dependent on the delivery format or type of electronic device used to view the personalized account reconfiguration interface. Thus, while twelve object placeholders were included within account reconfiguration interface template 206, only eight user content items 508a-h are displayed within personalized account reconfiguration interface 506. The reduction in the number of user content items displayed may reflect the fact that personalized account reconfiguration interface 506 is displayed within an e-mail client while account reconfiguration interface template 206 was displayed within a web browser. Therefore, if the user had viewed personalized account reconfiguration interface 506 in a web browser, demonstration portion 504 may have more closely resembled demonstration portion 204 of FIG. 2. Similar layout optimizations may be performed based on other criteria, such as the type of electronic device on which the personalized account reconfiguration interface is viewed.

User content items 508a-h may be images the user stored in a file system of a client electronic device accessible by a content management application, images the user stored in a remote file system accessible by a content management application, images the user has synched with a content management system, images not directly accessible to a content management application (e.g., “guessed” file path/file name combinations), and/or default objects provided by the content management system. As one example, user content items 508a-g may represent all of the user's images that were accessible to the content management system in one way or another. Meanwhile, user content item 508h may be a default image provided by the content management system to fill in demonstration portion 504.

FIG. 6 depicts user interface 600 including illustrative personalized account reconfiguration interface 606, in accordance with some embodiments. In particular, user interface 600 can include personalized account reconfiguration interface 606 in within an Internet browser application. Personalized account reconfiguration interface 606 may incorporate user content items 608 within demonstration portion 604. User interface 600 may also include Internet browser user interface elements, such as an address bar, bookmarks, and navigation buttons, and upgrade portion 620. In particular, user interface 600 may include personalized account reconfiguration interface 606 associated with features for editing, recording, sharing, and selling audio files.

Because audio files are not as inherently visual as image and video files, object placeholders in account reconfiguration interface templates that are primarily associated with audio files (or other primarily nonvisual content items) may be replaced with user content items that represent attributes (e.g., name, length, etc.) of the user's files rather than the content item itself (or a thumbnail version of the content item). Accordingly, demonstration portion 604 can include user content items 608, wherein the user content items represent one or more attributes (e.g., title, length, album, artist) related to underlying user files. User content items 608 may be displayed as part of demonstration portion 604 in the same or in a similar layout as is used for the account reconfiguration being presented in personalized account reconfiguration interface 606.

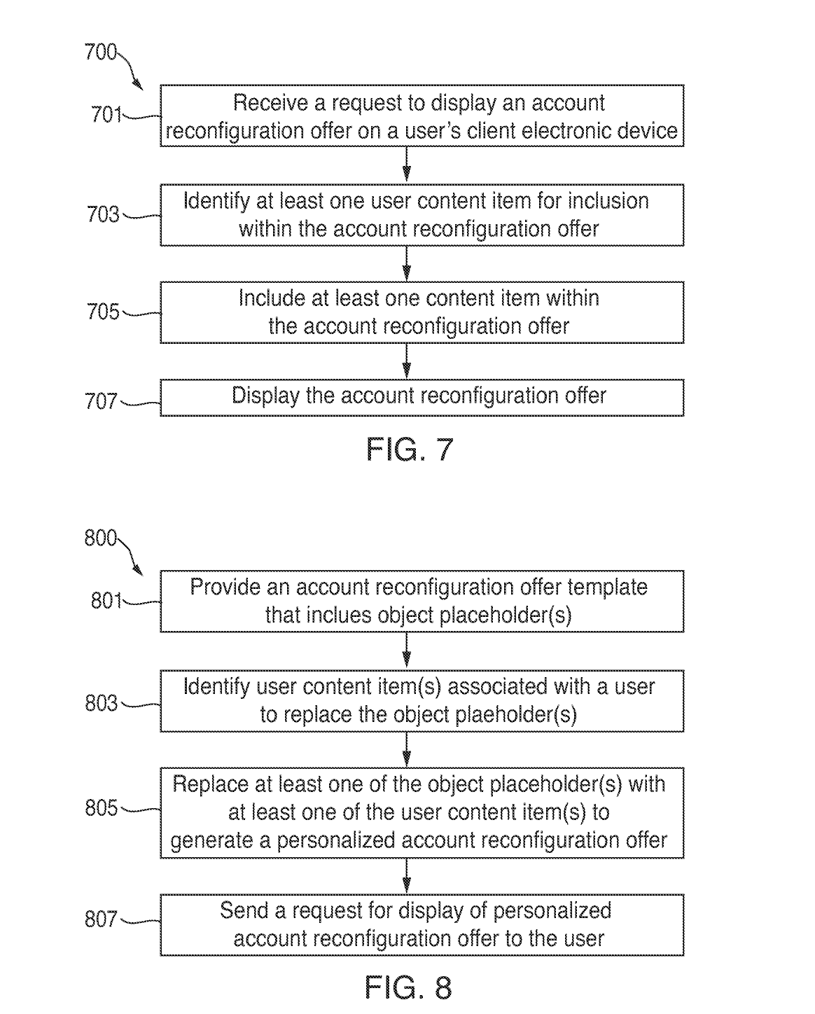

FIG. 7 shows a flowchart of process 700 for generating a personalized account reconfiguration interface, in accordance with some embodiments. Process 700 can begin at step 701, in which a request can be received at a user's client electronic device to display a personalized account reconfiguration interface. The personalized account reconfiguration interface (e.g., personalized account reconfiguration interface 506 of FIG. 5) can be an enticement to add and/or change one or more aspects of a user account registered with a content management system (e.g., content management system 100 of FIG. 1). For example, the personalized account reconfiguration interface may include an option to activate one or more available features of the content management system, to increase storage capacity for a user account of the content management system, and/or to create an account with the content management system. According to some embodiments, the personalized account reconfiguration interface can be an enticement to activate features that are primarily associated with one or more specific content types (e.g., photos, videos, audio files, etc.).

The request may be an electronic request provided to the client electronic device from the content management system over a communications network (e.g., network 106 of FIG. 1). According to some embodiments, the request can include an account reconfiguration interface template (e.g., account reconfiguration interface template 206 of FIG. 2) that includes one or more object placeholders (e.g., object placeholders 202a-l of FIG. 2).

At step 703, at least one user content item can be identified for inclusion within the account reconfiguration interface. User content items may be files (e.g., files 110 of FIG. 1) or attributes of files (e.g., metadata associated with files 110 of FIG. 1) associated with the user. For example, the user content items may be files (or associated metadata) stored locally on the client electronic device, stored remotely on another electronic device accessible by the client electronic device and/or the content management system, and/or stored in a data store (e.g., data store 118 of FIG. 1) of the content management system.

Depending on the location of the user content items, different modules can perform the identifying function. If the user content items are stored locally on the client electronic device or on another electronic device accessible with the client electronic device, for example, a content management application (e.g., content management application 114a of FIG. 1) installed on the client electronic device can identify the user content items. On the other hand, if the user content items are stored in the data store of the content management system, a module of the content management system (e.g., search module 144 of FIG. 1) can perform the identifying function.

According to some embodiments, identifying the content items may include filtering user content items by one or more particular content types. Such a request may be appropriate, for example, if the presented account reconfiguration is primarily associated with a particular type of content. In one particular example, the personalized account reconfiguration interface may include an enticement to upgrade to advanced photo editing and sharing features available using the content management system (i.e., primarily associated with photos). Accordingly, the request may specify that the user content items identified for inclusion within the account reconfiguration interface should be image files. The user content items may be filtered by file type using any suitable method, such as filtering by file extension type or using metadata values tags that identify the file's type.

According to some embodiments, identifying content items may additionally or alternatively include sorting the user content items using one or more sorting algorithms. Sorting algorithms may be applied to the user content items according to various criteria, such as identifying a certain number of user content items, recent user content items, older user content items, user content items associated with a certain person, place, or time, or any other suitable criteria.

In still further embodiments, the request may be sent to a user who does not have an authenticated account with the content management system. In such embodiments, the content management system may not have direct access to any of the user's user content items. Rather, the content management system may identify user content items by inserting typical file path/file name combinations into the account reconfiguration interface template received with the request. If the typical file path/file name combinations do not match any user content items stored locally on the client electronic device, default content items supplied by the content management system may be identified for inclusion with in the account reconfiguration interface.

At step 705, at least one of the identified user content items can be included within the account reconfiguration interface. According to some embodiments, the content management application installed on the client electronic device can embed the user content items within the account reconfiguration interface template received with the request. Such embodiments may require the client management application to be executing on the client electronic device when the request is received until step 707 when the personalized account reconfiguration interface is displayed.

If a client management application is either not installed on the client electronic device or not executing at the time the request is received, the user content items may be transmitted back to the content management system. A personalized account reconfiguration interface can then be received from the content management system at the electronic device (e.g., after a module of the content management system embeds the user content items within the account reconfiguration interface). One benefit of the latter embodiments is that the personalized account reconfiguration interface can be received at the client electronic device using any suitable delivery method (e.g., via e-mail, via an Internet web page, or via the content management application).

In still further embodiments, such as embodiments in which the identified user content items are stored in the data store of the content management system, a module of the content management system (e.g., interface module 104 of FIG. 1) can simply embed user content items stored in the data store in place of the object placeholders within the account reconfiguration template to generate the personalized account reconfiguration interface.

At step 707, the personalized account reconfiguration interface can be displayed to the user. For example, the personalized account reconfiguration interface can be displayed on a display screen of the client electronic device. The personalized account reconfiguration interface can be displayed in any suitable application installed on the client electronic device, such as an Internet browser, an e-mail program, or a content management application, for example.

FIG. 8 shows a flowchart of process 800 for generating a personalized account reconfiguration interface, in accordance with some embodiments. Process 800 can begin at step 801, in which an account reconfiguration interface template can be provided at a content management system. The an account reconfiguration interface template can include object placeholders (e.g., object placeholders 202a-l of FIG. 2) that may be replaced with one or more user content items (e.g., user content items 508a-h of FIG. 5) to generate a personalized account reconfiguration interface. In some embodiments, the account reconfiguration interface template may be provided to a user's client electronic device (e.g., client electronic device 102a of FIG. 1) over a network (e.g., network 106 of FIG. 1). In other embodiments, however, the account reconfiguration interface template may never be transmitted to a client electronic device.

At step 803, the content management system can identify user content items to replace the object placeholders. According to some embodiments, a search module (e.g., search module 144 of FIG. 1) of the content management system can be utilized to identify user content items stored in a data store (e.g., data store 118 of FIG. 1). The user content items may be, for example, files (e.g., files 134) that a user has chosen to store remotely with the content management system. Such user content items may be resident only in the data store or in both the data store and at least one client electronic device (e.g., synchronized). Identifying the user content items may involve filtering the user content items by file type and/or sorting the user content items according to various criteria to find suitable user content items to replace the object placeholders.

In other embodiments, the content management system can communicate a request to a content management application installed on the user's client electronic device to identify user content items. In these embodiments, the continent management application can perform the identifying functions of filtering and/or sorting user content items stored on the client electronic device in order to find suitable user content items to replace the object placeholders. The identified user content items may be communicated back to the content management system for inclusion within the account reconfiguration interface template and/or the account reconfiguration interface template may be transmitted to the client electronic device.

In still further embodiments, the content management system can provide the account reconfiguration interface template to a client electronic device with the object placeholders representing typical file path/file name combinations. In these embodiments, the identifying step can include determining whether the representing typical file path/file name combinations match any user content items stored on the client electronic device.

At step 805, at least one of the object placeholders may be replaced with at least one of the identified user content items to generate a personalized account reconfiguration interface. Depending on how the user content items were identified, the replacing step can occur at the content management system or the client electronic device. For example, if the content management system identifies the user content items in step 805 or the content management system receives identified user content items from the client electronic device, a module of the content management system can replace the object placeholders with the identified user content items. On the other hand, if the user content items are not transferred back to the content management system, the identified user content items can replace the object placeholders at the client electronic device (e.g., using the content management application).

At step 807, the personalized account reconfiguration interface can be displayed to the user. In some embodiments, the interface module of the content management system can transmit a request to display the personalized account reconfiguration interface on a display of the client electronic device. Displaying the personalized account reconfiguration interface to the user may further include transmitting the personalized account reconfiguration interface to the client electronic device (e.g., if the personalized account reconfiguration interface was generated at the content management system).

### Exemplary Implementations

Any suitable programming language can be used to implement the routines of particular embodiments including, but not limited to, the following: C, C++, Java, JavaScript, Python, Ruby, CoffeeScript, assembly language, etc. Different programming techniques can be employed, such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time

Particular embodiments may be implemented in a computer-readable storage device or non-transitory computer readable medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium, such as a storage device, to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While there have been described methods for date and time handling thereof, it is to be understood that many changes may be made therein without departing from the spirit and scope of the invention. Insubstantial changes from the claimed subject matter as viewed by a person with ordinary skill in the art, no known or later devised, are expressly contemplated as being equivalently within the scope of the claims. Therefore, obvious substitutions now or later known to one with ordinary skill in the art are defined to be within the scope of the defined elements. The described embodiments of the invention are presented for the purpose of illustration and not of limitation.

What is claimed is:

1. A computer-implemented method, comprising:
receiving, at a client electronic device, a request to display a personalized account reconfiguration interface for a user account authenticated with a content management system;
identifying at least one user content item of a plurality of user content items for inclusion within the personalized account reconfiguration interface;
including the at least one user content item within the personalized account reconfiguration interface; and
displaying the personalized account reconfiguration interface on a display of the client electronic device.

2. The method of claim 1, wherein the request comprises an account reconfiguration interface template comprising at least one object placeholder.

3. The method of claim 2, wherein the including comprises replacing the at least one object placeholder with the at least one user content item.

4. The method of claim 2, wherein the identifying comprises inserting typical file path/file name combinations into the account reconfiguration interface template.

5. The method of claim 1, wherein the personalized account interface is primarily associated with a specific content type.

6. The method of claim 5, wherein the identifying comprises filtering the plurality of user content items by content type, and wherein a content type of the at least one user content item matches the specific content type.

7. The method of claim 1, wherein a content management application installed on the client electronic device performs the identifying.

8. The method of claim 7, wherein the plurality of user content items is stored at least one of: (i) locally in a memory of the client electronic device;
and (ii) remotely in a memory accessible with the content management application.

9. The method of claim 1, wherein the identifying comprises sorting the plurality of user content items according to a sorting criteria, the sorting criteria comprising at least one of:
recently accessed user content items;
recently stored user content items;
recently shared user content items;
user content items that include a particular face;
user content items that include a particular scene;
user content items having a particular color, and
user content items having a similar size.

10. A nontransitory computer-readable medium for generating personalized account reconfiguration interfaces, the nontransitory computer-readable medium comprising instructions recorded thereon for:
providing, with a content management system, an account reconfiguration interface template comprising at least one object placeholder;
identifying at least one user content item of a plurality of user content items to replace the at least one object placeholder;
replacing at least one of the at least one object placeholder with the at least one user content item to generate a personalized account reconfiguration interface; and
transmitting a request for display of the personalized account reconfiguration interface.

11. The nontransitory computer-readable medium of claim 10, wherein a search module of the content management system performs the identifying.

12. The nontransitory computer-readable medium of claim 11, wherein the plurality of content items is stored in a data store of the content management system.

13. The nontransitory computer-readable medium of claim 12, wherein the identifying comprises filtering the plurality of user content items such that a content type of the at least one user content item matches a specific content type associated with the account reconfiguration interface template.

14. The nontransitory computer-readable medium of claim 12, wherein the identifying comprises sorting the plurality of user content items according to a sorting criteria, the sorting criteria comprising at least one of:
content items less frequently accessed by the user relating to a content purging feature, the content purging feature to store said content items in the data store and purge said content items from the user device;
content items that contain one or more defined faces or scenes relating to an organizing feature, the organizing feature to categorize and group content items based on the one or more defined faces or scenes; and
content items that contain documents relating to a document classifier feature, the document classifier feature to classify images as containing particular documents.

15. The nontransitory computer-readable medium of claim 10, wherein the identifying comprises:
transmitting, from the content management system, a request to a client management application installed on a client electronic device to identify the at least one user content item from among a plurality of user content items stored in a memory of the client electronic device.

16. The nontransitory computer-readable medium of claim 15, wherein the request comprises at least one of (i) content type filtering and (ii) sorting criteria for identifying the at least one user content item.

17. An electronic device, comprising:
a processor;
a display device;
communications circuitry; and
a memory, the memory comprising instructions for:
receiving a request to display a personalized account reconfiguration interface on the display device, the request comprising an account reconfiguration interface template and at least one criteria for identifying at least one user content item to include within the account reconfiguration interface template;
identifying the at least one user content item; and
including the at least one user content item within the account reconfiguration interface template to generate the personalized account reconfiguration interface; and
displaying the personalized account reconfiguration offer on the display.

18. The electronic device of claim 17, wherein the personalized account reconfiguration interface comprises a demonstration portion comprising the at least one user content item, the demonstration portion being one of:
a fully functional demonstration of an account reconfiguration presented in the personalized account reconfiguration interface;
a partially functional demonstration of an account reconfiguration presented in the personalized account reconfiguration interface; and
a nonfunctional mockup version of functional demonstration of an account reconfiguration presented in the personalized account reconfiguration interface.

19. The electronic device of claim 17, wherein the account reconfiguration interface template comprises at least one object placeholder, and wherein the including comprises embedding the at least one user content item within the account reconfiguration interface template in place of at least one of the at least one object placeholder.

20. The electronic device of claim 17, wherein the account reconfiguration interface template comprises at least one object placeholder, and wherein the including comprises replacing at least one of the at least one object placeholder with one of a destination link and a file path/file name combination for the at least one user content item.
